(19) United States
(12) Patent Application Publication
(10) Pub. No.: US 2025/0353374 A1
(43) Pub. Date: Nov. 20, 2025

(54) DISPLAY DEVICE AND DISPLAY METHOD FOR VEHICLE BEHAVIOR

(71) Applicant: TOYOTA JIDOSHA KABUSHIKI KAISHA, Toyota-shi (JP)

(72) Inventors: Takuya ADACHI, Toyota-shi (JP); Hideaki OTSUBO, Aichi-gun (JP); Tsutomu MIYAZAKI, Miyoshi-shi (JP)

(73) Assignee: TOYOTA JIDOSHA KABUSHIKI KAISHA, Toyota-shi (JP)

(21) Appl. No.: 19/013,510

(22) Filed: Jan. 8, 2025

(30) Foreign Application Priority Data
May 17, 2024 (JP) 2024-080656

(51) Int. Cl. B60K 35/28

(52) U.S. Cl. CPC B60K 35/28; B60K 2360/167; B60K 2360/188

(57) ABSTRACT

The display device disclosed in the present specification draws a band having a width corresponding to the magnitude of the lateral acceleration at each position on a side opposite to the direction of the lateral acceleration of the vehicle at each position of the travel path along the travel path of the vehicle. When the vehicle turns along a curve, lateral acceleration toward inside of the curve is generated in the vehicle. In the display device disclosed in the present specification, a band spreading to outside of the curve is drawn along the travel path. The greater the lateral acceleration is, the wider the band is.

### CROSS-REFERENCE TO RELATED APPLICATION

This application claims priority to Japanese Patent Application No. 2024-080656 filed on May 17, 2024, incorporated herein by reference in its entirety.

### BACKGROUND

### 1. Technical Field

The technology disclosed in the present specification relates to a display device and a display method for vehicle behavior (in particular, lateral-direction acceleration).

### 2. Description of Related Art

A display device for displaying a travel path of a vehicle and acceleration of the vehicle is disclosed in Japanese Unexamined Patent Application Publication No. 2012-133023 (JP 2012-133023 A). Also, a device for displaying recommended acceleration forward on a travel route of a vehicle is disclosed in WO2015/029181. In the display device of JP 2012-133023 A, each of travel path, speed, and the acceleration is displayed in an individual window. The speed is represented by a time chart in which the horizontal axis corresponds to time and the vertical axis corresponds to speed. The acceleration is represented by a graph in which the vertical axis corresponds to front-rear-direction acceleration and the horizontal axis corresponds to lateral-direction acceleration. The display device in JP 2012-133023 A is used for evaluation of driving skills. Hereinafter, the lateral-direction acceleration generated in the vehicle may be simply referred to as “lateral acceleration”, and the acceleration in a front-rear direction of the vehicle may be simply referred to as “front-rear acceleration”.

### SUMMARY

When the travel path and the acceleration are displayed separately, it is difficult to comprehend a correlation between each position on the travel path and the acceleration at these positions. The present specification provides a display device and a display method that facilitate comprehension of lateral acceleration at each position on a travel path.

The display device disclosed in the present specification displays a behavior of a vehicle. The display device draws, along the travel path, a band of width corresponding to the magnitude of the lateral acceleration of the vehicle at each position of the travel path of the vehicle. The band representing acceleration is drawn on a side opposite to a direction of the lateral acceleration of the travel path. When the vehicle turns along a curve, lateral acceleration toward inside of the curve is generated in the vehicle. In the display device disclosed in the present specification, a band spreading to outside of the curve is drawn along the travel path. The greater the lateral acceleration is, the wider the band is.

With the display device disclosed in the present specification, the wider the width of the band is, the greater the lateral acceleration at that position can be understood to be. According to the display device disclosed in the present specification, a user can easily comprehend the lateral acceleration at each position on the travel path. When the width of the band that is drawn in one curve is constant, this means that the lateral acceleration is constant, and when the width of the band greatly varies, the lateral acceleration can be understood to vary greatly in the curve. That is to say, according to the display device disclosed in the present specification, the skill of the driver when making a curve can be understood at a glance. The display device disclosed in the present specification is suitable for evaluating the skills of a driver traveling on a racing circuit. The display device may draw the travel path along with the band.

In the display device disclosed in the present specification, it is further preferable that a color or a concentration of the color of the band is made to vary at each of the positions in accordance with a magnitude of front-rear acceleration of the vehicle. For example, the display device draws a travel path in a darker color the greater the front-rear acceleration is. Also, it is preferable to select the color for acceleration in a forward direction and the color for acceleration in a rearward direction in a relation of complementary colors. According to this display device, the user can easily comprehend the lateral acceleration and the front-rear acceleration at each position on the travel path.

The display device disclosed in the present specification may further draw bands of a plurality of vehicles traveling on one route, superimposed. According to this display device, skill differences among drivers can be comprehended at a glance. Note that the band that is drawn above preferably is drawn such that the band that is drawn below can be seen therethrough.

The present specification also provides a display method in which the lateral acceleration at each position of the travel path is easily comprehended. In the display method, a band is drawn having a width that corresponds to a magnitude of lateral acceleration at each position of a travel path of the vehicle, along the travel path, on a side opposite to a direction of the lateral acceleration. In the display method, further, a color or a concentration of the color of the band is preferably made to vary at each of the positions in accordance with a magnitude of front-rear acceleration of the vehicle. In addition, in this display method, a travel path of a constant width line may be drawn superimposed on the band. Also, in this display method, bands of a plurality of vehicles traveling on one route may be drawn superimposed.

Details of the technology disclosed in the present specification and further improvements will be described in the “DETAILED DESCRIPTION OF EMBODIMENTS” below.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an example of a screen of a display device according to an embodiment;

FIG. 2 is another display example of the display device of the embodiment;

FIG. 3 is a display example of a travel path and an acceleration band of another vehicle;

FIG. 4 is a view showing a plurality of travel paths and acceleration bands in a superimposed manner; and

FIG. 5 is a block diagram illustrating a structure of a display device.

### DETAILED DESCRIPTION OF EMBODIMENTS

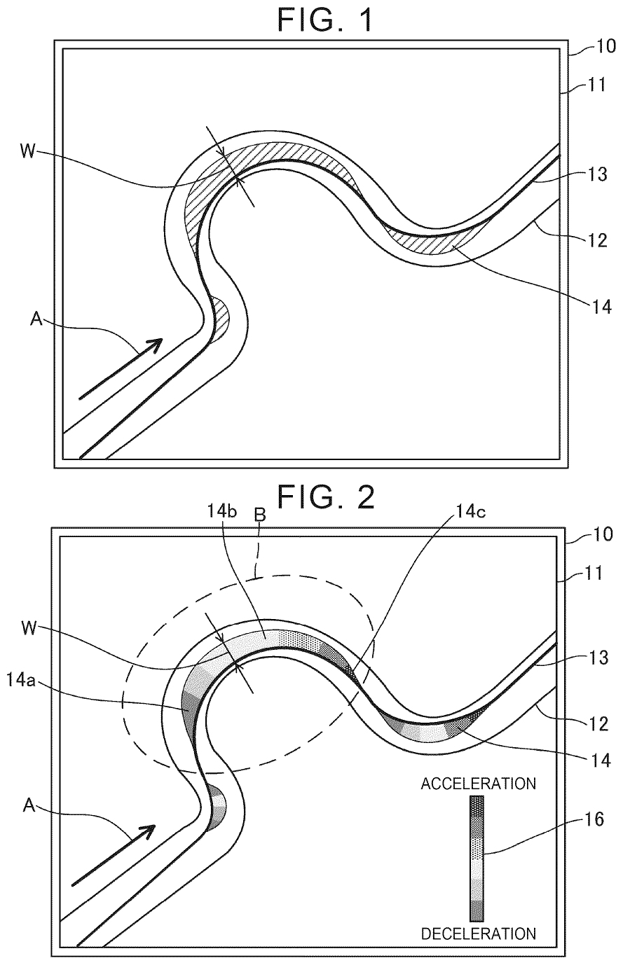

A display device 10 according to an embodiment will be described with reference to the drawings. FIG. 1 illustrates an example of a screen 11 of the display device 10. The display device 10 draws, on the screen 11, a travel path 13 when the vehicle travels on the course 12 of the circuit and a band 14 representing the magnitude of the lateral acceleration of the vehicle. The travel path and the lateral acceleration are parameters representing the behavior of the vehicle. That is, the display device 10 is a device representing the behavior of the vehicle. The behavior of the vehicle may also include acceleration and speed in the front-rear direction. The display device 10 may display these parameters.

In FIG. 1, the travel path 13 is drawn by a thick line having a constant width. An arrow A in FIG. 1 indicates a traveling direction of the vehicle. Arrow A is drawn to aid understanding herein and may not be practical. In the following description, for the sake of simplicity, the “band 14 representing the magnitude of the lateral acceleration of the vehicle” may be referred to as “band 14 representing the lateral acceleration of the vehicle” or simply as “band 14 of the lateral acceleration”.

The band 14 representing the lateral acceleration is drawn along the travel path 13. The display device 10 draws the band 14 representing the lateral acceleration such that the edge thereof is in contact with the travel path 13. The width W of the band 14 corresponds to the magnitude of the lateral acceleration of the vehicle at each position of the travel path 13. In other words, the width W of the band 14 is proportional to the magnitude of the lateral acceleration of the vehicle at each position of the travel path 13. The proportional constant at the time of converting the lateral acceleration into the width W is appropriately determined so as to be easy for the user to see.

The band 14 representing the lateral acceleration is drawn on the side opposite to the direction of the lateral acceleration at each position of the travel path 13. The lateral acceleration of the vehicle faces the inside of the curve. Therefore, the band 14 representing the lateral acceleration is drawn on the outside of the curve along the travel path. In other words, in the band 14 representing the lateral acceleration, the width W is proportional to the magnitude of the lateral acceleration at each position of the travel path 13, and is drawn on the outside of the curve of the travel path 13 along the travel path 13. The band 14 is drawn on the outside of the curve of the travel path 13 such that its edge is in contact with the travel path 13.

The band 14 extending outside the curve of the travel path 13 represents, in other words, a centrifugal force applied to the driver. The wider the width W, the greater the lateral acceleration and the greater the centrifugal force applied to the driver.

The display device 10 draws the band 14 having the width W corresponding to the lateral acceleration along the travel path 13. According to this display mode, the user can easily grasp the magnitude of the lateral acceleration at each position of the travel path.

The magnitude of the lateral acceleration in the curve depends on the skills of the driver (handle work and accelerator work). Even if the handle workpiece changes frequently, the swing (fluctuation) of the travel route is small, and it is difficult to grasp the handle workpiece from the travel route. However, a slight change in the handle workpiece has a large influence on the lateral acceleration. The variation of the width W of the band 14 represents the variation of the handle workpiece. Also, when the brake is strongly depressed in the middle of the curve, the lateral acceleration greatly changes. A small change in the width W of the band 14 means that the handle work and the accelerator work have been performed so that the lateral acceleration does not change abruptly. The display device 10 is suitable for evaluating the skill of the driver.

Since the lateral acceleration does not occur while the vehicle is traveling straight, the width W of the band 14 becomes zero.

The data of the travel path is obtained from a positioning sensor mounted on the vehicle. The lateral acceleration at each position of the travel path is obtained from an acceleration sensor mounted on the vehicle. Alternatively, the lateral acceleration may be obtained from the point sequence of the travel path. Vehicle speed is obtained from the distance between the point trains. The curvature of the curve is obtained from the arrangement of the series of points. The lateral acceleration is obtained from the curvature of the curve and the vehicle speed. The display device 10 generates and renders the travel path 13 and the band 14 of the lateral acceleration using data (and data of the lateral acceleration) of the travel path obtained from the vehicle traveling on the course 12.

FIG. 2 shows another example of the screen 11 of the display device 10. In FIG. 2, the width W of the band 14 corresponds to the magnitude of the lateral acceleration, and the color (or color density) of the band 14 corresponds to the front-rear acceleration of the vehicle. In the lower right of the screen 11, a bar graph 16 representing the correspondence between the color density and the acceleration is drawn. The color of the acceleration in the forward direction and the color of the acceleration in the back ward direction are selected in relation to the complementary color, although it is difficult to understand because the drawing is monochrome. For example, the acceleration in the backward direction is represented by red, and the acceleration in the forward direction is represented by green. Red and green are complementary colors. Also, the greater the absolute value of the acceleration, the darker the band 14 is drawn. In corner B of FIG. 2, the band 14a near the corner entrance is drawn in dark red, and the band 14c near the corner exit is drawn in dark green. The band 14b near the center of the corner is drawn in light red or light green. With these color schemes, the user can easily grasp the front-rear acceleration together with the lateral acceleration at each position of the travel path 13.

Note that the band 14 in which the width W represents the magnitude of the lateral acceleration may be color-coded in accordance with the front-rear acceleration, and the line of the travel path 13 may be color-coded in accordance with the speed of the vehicle.

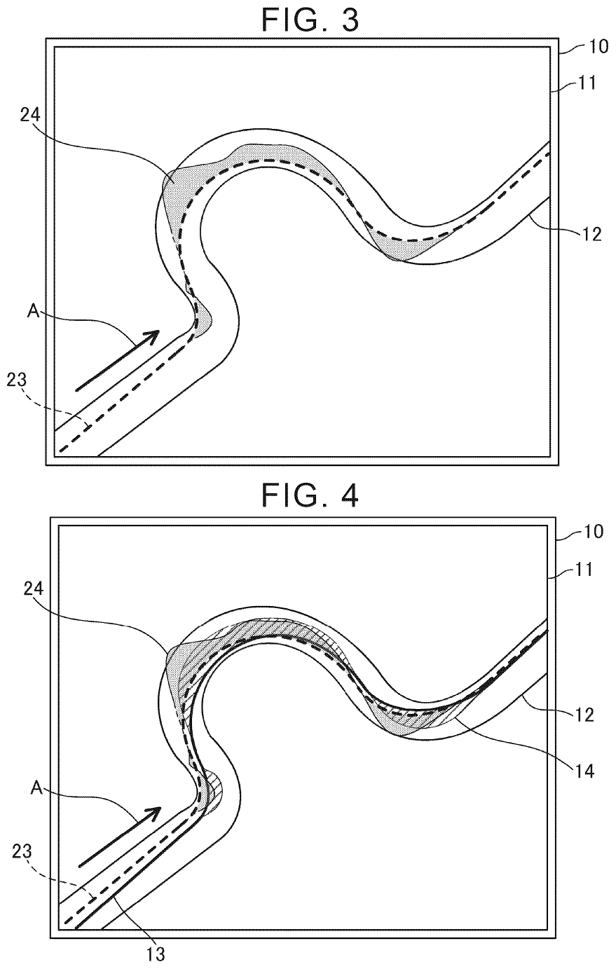

FIG. 3 shows an example of the travel path 23 of another vehicle traveling on the course 12 of the circuit and the band 24 of the lateral acceleration. The travel path 23 is drawn by a thick dotted line having a constant width. The width of the band 24 corresponds to the magnitude of the lateral acceleration of the vehicle at each position of the travel path 23. The band 24 is drawn along the travel path 23. The band 24 is drawn on the side opposite to the direction of the lateral acceleration at each position of the travel path 23 (that is, on the outer side of the curve of the travel path 23). In the example of FIG. 3, the variation of the band 24 is large. That is, it can be easily understood from FIG. 3 that the skill of the driver of the vehicle in the travel path 23 is low.

FIG. 4 shows an example in which the travel path 23 and the band 24 of FIG. 3 are superimposed on the travel path 13 and the band 14 of FIG. 1. That is, in FIG. 4, travel paths 13 and 23 and bands 14 and 24 of a plurality of vehicles traveling on one route (course 12) are depicted in a superimposed manner. The travel path 23 and the band 24 drawn on the upper side are drawn so that the travel path 13 and the band 14 drawn on the lower side can be seen through.

In the band 14, the fluctuation of the width at the corner is gentle. That is, it can be seen that the driver of the vehicle having the travel path 13 has a high skill. As described above, the driver of the travel path 23 has a low skill. By superimposing the traveling routes and the bands (bands representing lateral accelerations) of the plurality of vehicles traveling on one route, it is possible to clearly grasp the difference in the skill of the driver. Further, from the display of FIG. 4, a driver with low skill can easily grasp a weak point of his/her skill.

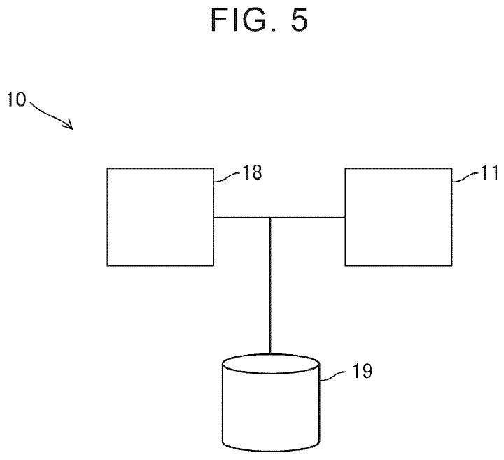

FIG. 5 is a block diagram of a structure of the display device 10. The display device 10 includes a screen 11, a computer 18, and a storage device 19. The storage device 19 stores data of a travel path of the vehicle. The storage device 19 may store data of the speed, the front-rear acceleration, and the lateral acceleration at each position of the travel path of the vehicle. The computer 18 displays the travel path 13 and the band 14 representing the lateral acceleration on the screen 11 based on the data stored in the storage device 19. As described above, the computer 18 may calculate the speed and the lateral acceleration of the vehicle from the point train of the travel path. When the data of the travel path, the speed, the front-rear acceleration, and the lateral acceleration can be acquired from the vehicle, the computer 18 may draw the band 14 using the data.

As described above, the display device 10 displays the behavior of the vehicle. Specifically, the display device 10 displays a band having a width corresponding to the magnitude of the lateral acceleration of the vehicle along the travel path. According to such a display mode, the user can easily grasp the lateral acceleration of the vehicle (in other words, the centrifugal force applied to the driver) at each position of the travel path. The display device 10 is particularly suitable for evaluating a driver's skill in a circuit or test course. Of course, the techniques disclosed herein are also suitable for evaluating the skill of a general driver.

In the following, attention is given to the technology described in the examples. In FIG. 4, the color coding of the bands 14 and 24 according to the acceleration in the front-rear direction of the vehicle is omitted in order to facilitate understanding. Even in a case where a plurality of travel routes and bands are drawn in a superimposed manner, the bands 14 and 24 may be color-coded according to the magnitude of the front-rear acceleration of the vehicle. In addition, the travel paths 13 and 23 may be color-coded according to the magnitude of the speed of the vehicle.

The width W of the band means the length of the band in a direction perpendicular to the traveling direction of the vehicle. The width W of the band is proportional to the magnitude of the lateral acceleration occurring in the vehicle.

The display device 10 draws a band 14 (24) having a width corresponding to the magnitude of the lateral acceleration along the travel path 13 (23). Although it is preferable to draw the travel path 13 (23) together with the band 14 (24), the travel path 13 (23) may not be drawn and only the band 14 (24) may be drawn. This is because it is obvious that the inner edge of the curve of the band 14 (24) represents the travel path. In this case, when the lateral acceleration is zero, the travel path may be drawn by a thin line. In a case where the travel path is drawn in addition to the band representing the lateral acceleration, the display device 10 may draw the band representing the lateral acceleration such that the edge thereof is in contact with the travel path.

The band 14 (24) may also be expressed as a travel path 13 (23). In this case, the characteristics of the display device disclosed in the present specification can be expressed as follows. The display device draws a travel path such that the width of the travel path is proportional to the magnitude of the lateral acceleration of the vehicle at each position. The travel path is drawn to extend outside the curve. In other words, the inner edge of the curve of the travel path of the width corresponding to the lateral acceleration corresponds to the original travel path.

When the cursor is placed on the travel path, the lateral acceleration (and the acceleration in the front-rear direction and the speed) at the position where the cursor is placed may be displayed in a pop-up manner. In addition, a band for a predetermined time (a band indicating lateral acceleration) may be sequentially displayed as a moving image.

In the technical field of automobiles, “acceleration” may be referred to as “G”. In this specification, “lateral acceleration” may be referred to as “lateral G”, and “front-rear acceleration” may be referred to as “longitudinal G”. Using such notation, the techniques disclosed herein can also be expressed as follows. That is, the display device (display method) disclosed in the present specification draws a band of width corresponding to the size of the lateral G of the vehicle at each position of the travel path of the vehicle along the travel path on the side opposite to the direction of the lateral G. In the display device (display method) disclosed in the present specification, the color of the band or the density of the color at each position of the travel path may be changed in accordance with the size of the front and rear G of the vehicle.

The present specification also discloses a novel method for displaying the lateral acceleration of a vehicle. The display method disclosed in the present specification draws a band of width corresponding to the lateral acceleration of the vehicle at each position of the travel path along the travel path of the vehicle. The band representing the lateral acceleration is drawn on the side opposite to the direction of the lateral acceleration of the vehicle at each position of the travel path. In other words, the band representing the lateral acceleration is drawn along the outside of the curve of the travel path. The width of the band (the width in a direction orthogonal to the traveling direction of the vehicle) is proportional to the magnitude of the lateral acceleration. In other words, the width of the band and the magnitude of the lateral acceleration have a positive correlation.

In the display method disclosed in the present specification, the color or the color density of the band at each position of the travel path is changed in accordance with the magnitude of the front-rear acceleration of the vehicle at each position. The lateral acceleration and the front-rear acceleration at each position of the travel path can be easily grasped.

In the display method disclosed in the present specification, the travel path may be drawn by a line having a constant width in addition to the band representing the lateral acceleration. The band representing the lateral acceleration may be drawn such that the edge thereof is in contact with the travel path. In addition, the color of the travel path may be changed according to the speed of the vehicle. Further, a plurality of bands of vehicles traveling on one travel route (bands representing lateral acceleration of each vehicle) may be drawn in a superimposed manner. In that case, the upper band may be drawn such that the lower band appears transparent.

Although the specific examples of the present disclosure have been described in detail above, these are merely examples and do not limit the scope of claims. The techniques described in the claims include various modifications and alternations of the specific examples illustrated above. The technical elements described in the present specification or the drawings exhibit technical usefulness alone or in various combinations, and are not limited to the combinations described in the claims at the time of filing. In addition, the techniques illustrated in the present specification or drawings can achieve a plurality of objectives at the same time, and achieving one of the objectives itself has technical usefulness.

What is claimed is:

1. A display device for vehicle behavior, the display device
drawing a band of a width that corresponds to a magnitude of lateral acceleration of a vehicle at each position of a travel path of the vehicle, along the travel path, on a side opposite to a direction of the lateral acceleration.

2. The display device according to claim 1, wherein a color or a concentration of the color of the band is made to vary at each of the positions in accordance with a magnitude of front-rear acceleration of the vehicle.

3. The display device according to claim 1, wherein the travel path of a constant width line is drawn superimposed on the band.

4. The display device according to claim 3, wherein the color of the travel path is made to vary in accordance with a speed of the vehicle.

5. The display device according to claim 1, wherein the bands of a plurality of vehicles traveling on one route are drawn superimposed.

6. A display method for vehicle behavior, the display method comprising:
drawing a band of a width that corresponds to a magnitude of lateral acceleration of a vehicle at each position of a travel path of the vehicle, along the travel path, on a side opposite to a direction of the lateral acceleration.

7. The display method according to claim 6, wherein a color or a concentration of the color of the band at each of the positions is made to vary in accordance with a magnitude of front-rear acceleration of the vehicle.

8. The display method according to claim 6, wherein the travel path of a constant width line is drawn superimposed on the band.

9. The display method according to claim 8, wherein the color of the travel path is made to vary in accordance with a speed of the vehicle.

10. The display method according to claim 6, wherein the bands of a plurality of vehicles traveling on one route are drawn superimposed.
